(19) United States
(12) Patent Application Publication
(10) Pub. No.: US 2015/0213253 A1
(43) Pub. Date: Jul. 30, 2015

(54) AUTHORIZING AN APPLICATION FOR USE BY A COMPUTING DEVICE

(71) Applicant: Qualcomm Incorporated, San Diego, CA (US)

(72) Inventors: Maria L. MIRANDA, Carlsbad, CA (US); Qazi Y. BASHIR, San Marcos, CA (US); Suresh BOLLAPRAGADA, San Diego, CA (US)

(73) Assignee: Qualcomm Incorporated, San Diego, CA (US)

(21) Appl. No.: 14/166,743

(22) Filed: Jan. 28, 2014

(51) Int. Cl. G06F 21/44

(52) U.S. Cl. CPC G06F 21/44

(57) ABSTRACT

Disclosed is an apparatus and method to authorize an application for use. A computing device may utilize an application and may include a secure memory and a processor. The processor may: create a unique digest for the application upon a first boot-up; store the unique digest in the secure memory; calculate an application digest for the application upon a subsequent boot-up; and if the calculated application digest matches the stored unique digest, authorize the application for use.

### BACKGROUND

1. Field

The present invention relates to an apparatus and method to authorize an application for use by a computing device.

2. Relevant Background

Typically, applications for a computing device are bound to the computing device and are authenticated for use. In present implementations, when an application is loaded upon boot-up, a signed digest and an application digest are generated to authenticate the application, both of which often utilize the serial number of the chip. The signed digest is based upon a signature that is decrypted with a public key stored in the boot ROM or the One Time Programmable Memory. The application digest is created by a hash function of the application in combination with the serial number. The signed digest is compared with the local calculated hash digest, and, if they are the same, then the application is authenticated. Otherwise, the application is not authenticated.

Unfortunately, this static signing based upon the unique serial number of the chip vendor has been found to be cumbersome.

### SUMMARY

Aspects of the invention may relate to an apparatus and method to authorize an application for use. A computing device may utilize an application and may include a secure memory and a processor. The processor may: create a unique digest for the application upon a first boot-up; store the unique digest in the secure memory; calculate an application digest for the application upon a subsequent boot-up; and if the calculated application digest matches the stored unique digest, authorize the application for use.

### BRIEF DESCRIPTION OF THE DRAWINGS

FIG. 1 is a diagram of a computing device in which aspects of the invention may be practiced.

FIG. 2 is a flow diagram illustrating an example of a process to determine whether an application is authorized for use.

FIG. 3 is a block diagram illustrating components that may be utilized to implement the process to authorize or not authorize an application for use.

FIG. 4 is an example of the process relating to functions utilized in determining the calculated application digest and authorizing or not authorizing the application for use.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the term “computing system or device” refers to any form of programmable computer device including but not limited to laptop and desktop computers, tablets, smartphones, televisions, home appliances, cellular telephones, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, or any data processing apparatus.

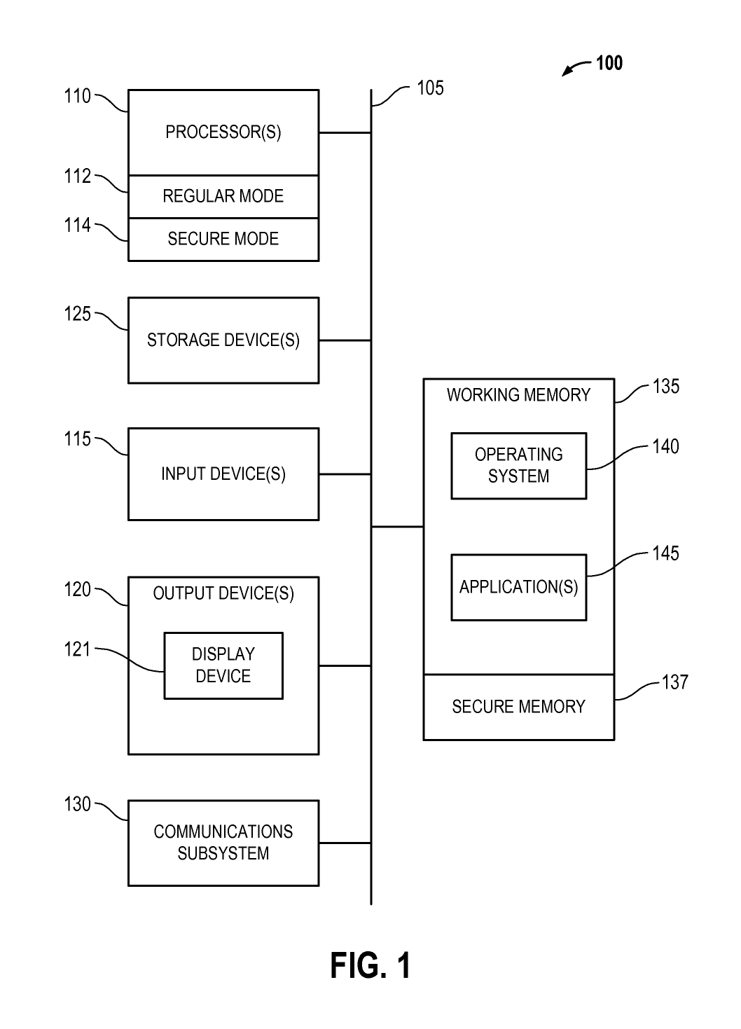

An example computing device 100 that may be utilized to authorize an application for use, as will be hereinafter described in detail, is illustrated in FIG. 1. The computing device 100 is shown comprising hardware elements that can be electrically coupled via a bus 105 (or may otherwise be in communication, as appropriate). The hardware elements may include one or more processors 110, including without limitation one or more general-purpose processors and/or one or more special-purpose processors (such as digital signal processing chips, graphics acceleration processors, and/or the like); one or more input devices 115 (e.g., keyboard, keypad, touchscreen, mouse, etc.); and one or more output devices 120, which include at least a display device 121, and can further include without limitation a speaker, a printer, and/or the like. Further, processor 110 may operate in a regular mode 112 and a secure mode 114.

The computing device 100 may further include (and/or be in communication with) one or more non-transitory storage devices 125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computing device 100 may also include a communication subsystem 130, which can include without limitation a mode, a network card (wireless or wired), an infrared communication device, a wireless communication device and/or chipset (such as a Bluetooth device, an 802.11 device, a Wi-Fi device, a WiMax device, cellular communication devices, etc.), and/or the like. The communications subsystem 130 may permit data to be exchanged with a network, other computer systems, and/or any other devices described herein. In many embodiments, the computing device 100 will further comprise a working memory 135, which can include a RAM or ROM device, as described above. Also, computing device 100 may include a secure memory 137 to aid in authorizing applications for use, as will be described in more detail later.

The computing device 100 may also comprise software elements, shown as being currently located within the working memory 135, including an operating system 140, applications 145, device drivers, executable libraries, and/or other code. In one embodiment, an application may be designed to implement methods, and/or configure systems, to implement embodiments of the invention, as described herein. Merely by way of example, one or more procedures described with respect to the method(s) discussed below may be implemented as code and/or instructions executable by a computing device (and/or a processor within a computing device); in an aspect, then, such code and/or instructions can be used to configure and/or adapt a general purpose computer (e.g., a computing device) to perform one or more operations in accordance with the described methods, according to embodiments of the invention.

A set of these instructions and/or code might be stored on a non-transitory computer-readable storage medium, such as the storage device(s) 125 described above. In some cases, the storage medium might be incorporated within a computer system, such as computing device 100. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computerized computing device 100 and/or might take the form of source and/or installable code, which, upon compilation and/or installation on the computing device 100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As previously described, the static signing of an application upon each boot-up based upon the unique serial number of the processor (e.g., from a chip vendor) by present conventional methods has been found to be cumbersome. As will be described, embodiments of the invention do not require a signature based upon the serial number of the processor for boot-ups. Aspects of the invention provide an apparatus and method to dynamically bind an application to a computing device without requiring a signature.

In particular, aspects of the invention may relate to an apparatus and method to authorize an application for use. In one embodiment, as will be described in more detail, computing device 100 may include a secure memory 137 and a processor 110 to authorize an application 145 for use. Processor 110 may operate in a secure mode 114 to execute operations including: creating a unique digest for the application 145 upon a first boot-up; storing the unique digest in the secure memory 137; calculating an application digest for the application 145 upon a subsequent boot-up; and if the calculated application digest matches the stored unique digest, authorizing the application for use. In this way, the application 145 may be bound to the computing device 100 on the first boot-up. As will be described, the application 145 may be dynamically bound to the computing device 100 on the first boot-up by calculating a unique digest for the application based upon a hash function of the application and the serial number of the processor 110 and saving it into a secure storage area, such as secure memory 137.

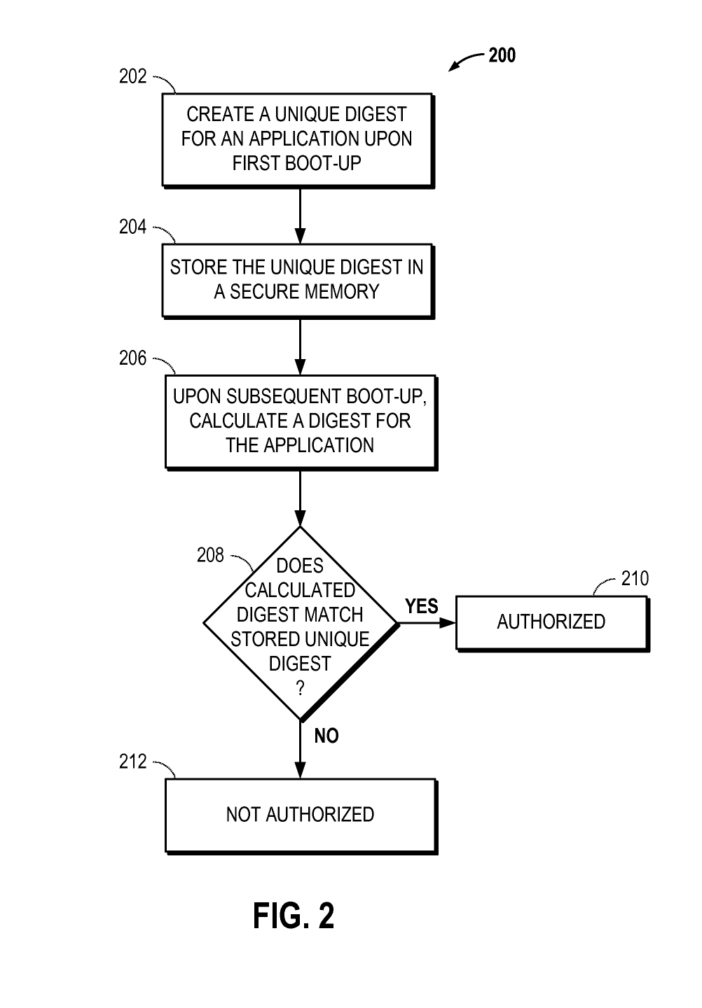

With additional reference to FIG. 2, a method process 200 to implement embodiments of the invention will be hereinafter described. At block 202, a unique digest for an application 145 is created by processor 110 operating in the secure mode 114 upon the first boot-up of the application. Next, at block 204, the unique digest is stored in secure memory 137 as commanded by processor 110 operating in the secure mode 114. At block 206, upon subsequent boot-up, processor 110 operating in the secure mode 114, calculates an application digest for the application 145. If at block 208, processor 110 operating in the secure mode 114 determines that the calculated digest matches the stored unique digest stored in the secure memory 137, then application 145 is authorized for use (block 210). However, if the calculated digest does not match the stored unique digest stored in secure memory 137, then application 145 is not authorized for use (block 212).

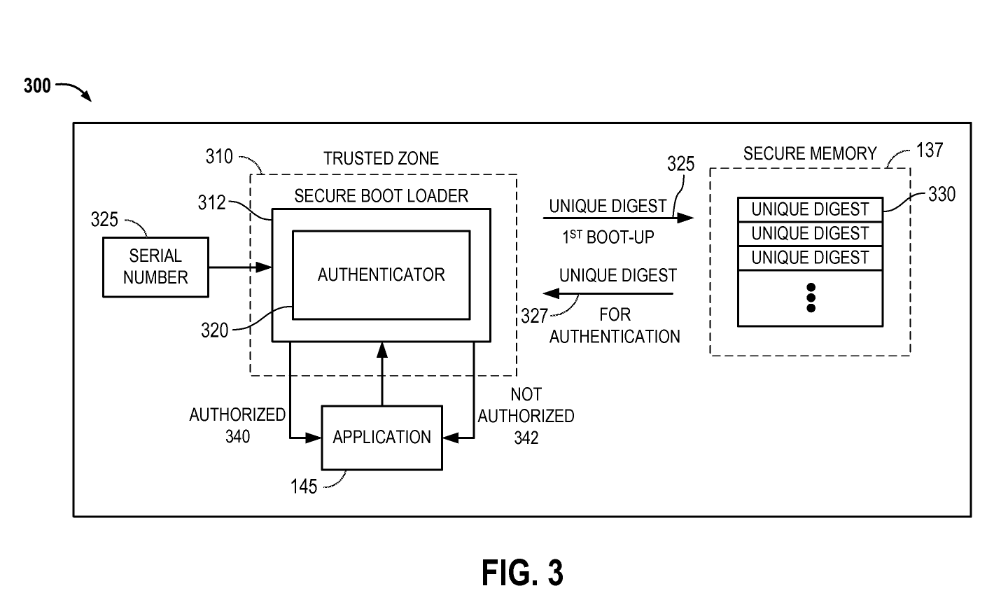

With additional reference to FIG. 3, a block diagram illustrating components that may be utilized to implement the process for authorizing or not authorizing the application, will be hereinafter described. In this example, processor 110 operates in the secure mode 114 to create a trusted zone 310 to execute secure operations including the secure operations of a secure boot loader 312 and a secure authenticator 320. For example, upon first boot-up, secure boot loader 312 creates a unique digest for an application 145 that is being loaded onto the computing device. For example, this may be done by a computing device manufacturer to load a licensed application for use on its computing device. The secure boot loader 312 may command that the unique digest for the 1^{st} boot-up 325 be stored as a unique digest entry 330 for that application in the secure memory 137. Upon a subsequent boot-up of the application 145 (e.g., by a purchaser of the computing device), authenticator 320 may calculate an application digest for the application 145 and compare it to the unique digest 327 previously stored for the application in secure memory 137. If the authenticator 320 determines that the calculated application digest matches the stored unique digest 327 for the application stored in secure memory 137, then the application 145 is authorized 340 for use by the computing device. On the other hand, if the authenticator 320 determines that the calculated application digest does not match the stored unique digest 327 for the application stored in secure memory 137, then the application 145 is not authorized 342 for use by the computing device. It should be appreciated that processor 110 operating in a secure mode 114 may implement the operations of the secure boot loader 312 and authenticator 320 previously described.

Various exemplary embodiments of functions, operations, and components will be hereinafter described. For example, the unique digest 325 for the first boot-up may be created based upon at least a hash function of the application 145. Further, the unique digest 325 for the first boot-up may be further based upon a concatenation of a serial number 325 associated with the processor and with the hash function of the application. This unique digest for the 1^{st} boot-up may be stored as a unique digest entry 330 for that application in the secure memory 137. Then, upon subsequent boot-up, a calculated application digest is determined based upon a concatenation of the serial number 325 associated with the processor and the hash function of the application 145. As previously described, if the authenticator 320 determines that the calculated application digest matches the stored unique digest 327 for the application stored in secure memory 137, then the application 145 is authorized 340 for use by the computing device. On the other hand, if the authenticator 320 determines that the calculated application digest does not match the stored unique digest 327 for the application stored in secure memory 137, then the application 145 is not authorized 342 for use by the computing device.

In one embodiment, the hash functions may be secure hash algorithms. Further, the secure memory 137 may include a protected memory block, such as, a replay protected memory block. However, it should be appreciated that any type of secure or protected type of memory or storage may be utilized.

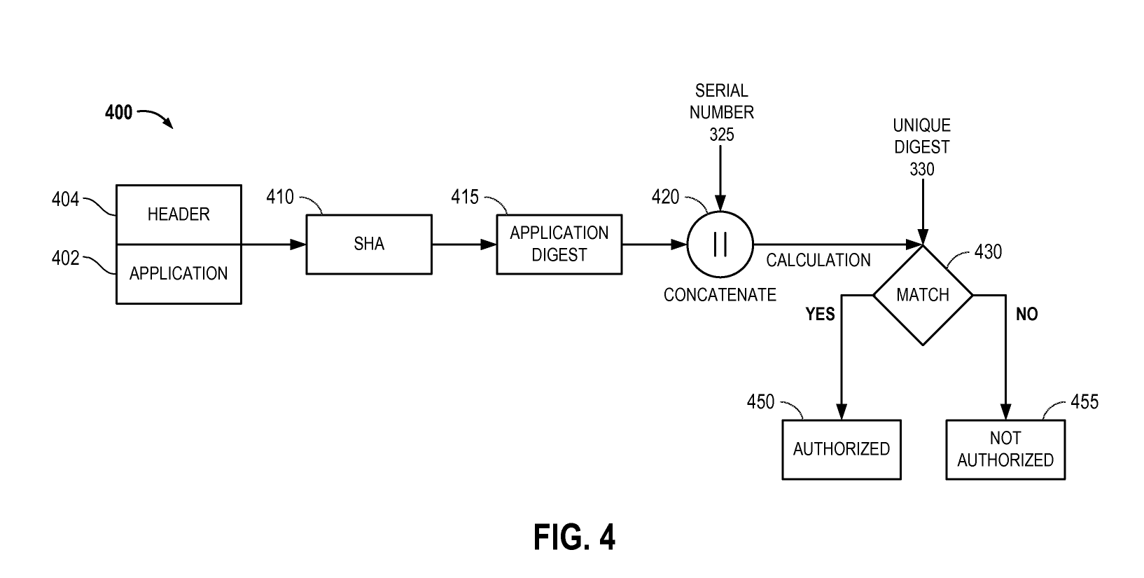

With additional reference to FIG. 4, an example of the process 400 relating to determining the calculated application digest and authorizing or not authorizing the application, will be hereinafter described. In one embodiment, as can be seen in process 400, a combination of the application 402 and a header 404, in a subsequent boot-up, are processed by a secure hashing algorithm 410 to create a first iteration of the calculated application digest 415. Next, the first iteration of the calculated application digest 415 is concatenated (block 420) with the serial number 325 associated with the processor to create the calculated application digest. At decision block 430, the authenticator determines whether the calculated application digest matches the stored unique digest 330 for the application stored in secure memory 137, and if so, the application is authorized 450 for use by the computing device. On the other hand, if the authenticator, at decision block 430, determines that the calculated application digest does not match the stored unique digest 327 for the application stored in secure memory 137, then the application 145 is not authorized 455 for use by the computing device.

Thus, as previously described, upon first boot-up, the secure boot loader 312 will first authenticate the application 145, and store the unique digest 330 for the application in secure memory 137. No signature process is required (such as signing with the serial number of the processor). Further, no signature process is required for authentication on subsequent boot-ups either. As previously described, in subsequent boot-ups, the secure boot loader 312 may authenticate the application 145. The digest of the application with a hash algorithm may be calculated and compared against the unique digest 330 saved and stored in the secure memory 137 from the first boot-up. Thus, the signing of each application is not required. This significantly improves the time efficiency in the authorization of applications.

It should be appreciated that aspects of the invention previously described may be implemented in conjunction with the execution of instructions by processors (e.g., processor 110) of the devices (e.g., computing device 100), as previously described. Particularly, circuitry of the devices, including but not limited to processors, may operate under the control of a program, routine, or the execution of instructions to execute methods or processes in accordance with embodiments of the invention (e.g., the processes and functions of FIGS. 2-4). For example, such a program may be implemented in firmware or software (e.g. stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc

It should be appreciated that when the devices are mobile or wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other suitable device. These devices may have different power and data requirements

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computing device comprising:
a secure memory; and
a processor to:
create a unique digest for an application upon a first boot-up;
store the unique digest in the secure memory;
calculate an application digest for the application upon a subsequent boot-up; and
if the calculated application digest matches the stored unique digest, authorize the application for use.

2. The computing device of claim 1, wherein if the calculated application digest does not match the stored unique digest, the application is not authorized for use.

3. The computing device of claim 1, wherein the unique digest is created based upon at least a hash function of the application upon the first boot-up.

4. The computing device of claim 3, wherein the unique digest is further created based upon a concatenation of a serial number associated with the processor and with the hash function of the application.

5. The computing device of claim 4, wherein the calculated application digest upon subsequent boot-up is based upon a concatenation of the serial number associated with the processor and the hash function of the application.

6. A method to authorize an application for use comprising:
creating a unique digest for the application upon a first boot-up;
storing the unique digest in a secure memory;
calculating an application digest for the application upon a subsequent boot-up; and
if the calculated application digest matches the stored unique digest, authorizing the application for use.

7. The method of claim 6, wherein if the calculated application digest does not match the stored unique digest, the application is not authorized for use.

8. The method of claim 6, wherein the unique digest is created based upon at least a hash function of the application upon the first boot-up.

9. The method of claim 8, wherein the unique digest is further created based upon a concatenation of a serial number associated with a processor and with the hash function of the application.

10. The method of claim 9, wherein the calculated application digest upon subsequent boot-up is based upon a concatenation of the serial number associated with the processor and the hash function of the application.

11. A non-transitory computer-readable medium including code that, when executed by a processor, causes the processor to:
create a unique digest for an application upon a first boot-up;
store the unique digest in a secure memory;
calculate an application digest for the application upon a subsequent boot-up; and
if the calculated application digest matches the stored unique digest, authorize the application for use.

12. The computer-readable medium of claim 11, wherein if the calculated application digest does not match the stored unique digest, the application is not authorized for use.

13. The computer-readable medium of claim 11, wherein the unique digest is created based upon at least a hash function of the application upon the first boot-up.

14. The computer-readable medium of claim 13, wherein the unique digest is further created based upon a concatenation of a serial number associated with the processor and with the hash function of the application.

15. The computer-readable medium of claim 14, wherein the calculated application digest upon subsequent boot-up is based upon a concatenation of the serial number associated with the processor and the hash function of the application.

16. A computing device comprising:
means for creating a unique digest for an application upon a first boot-up;
means for storing the unique digest in a secure memory;
means for calculating an application digest for the application upon a subsequent boot-up; and
if the calculated application digest matches the stored unique digest, authorizing the application for use.

17. The computing device of claim 16, wherein if the calculated application digest does not match the stored unique digest, the application is not authorized for use.

18. The computing device of claim 16, wherein the unique digest is created based upon at least a hash function of the application upon the first boot-up.

19. The computing device of claim 18, wherein the unique digest is further created based upon a concatenation of a serial number associated with a processor and with the hash function of the application.

20. The computing device of claim 19, wherein the calculated application digest upon subsequent boot-up is based upon a concatenation of the serial number associated with the processor and the hash function of the application.
